(19) United States
(12) Patent Application Publication
(10) Pub. No.: US 2001/0044787 A1
(43) Pub. Date: Nov. 22, 2001

(54) Secure private agent for electronic transactions

(76) Inventors: Gil Shwartz, Ramat Gan (IL); Shay Granov, Modi'in (IL); Guy Netef, Rishon Lezion (IL)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/737,148

(22) Filed: Dec. 14, 2000

Related U.S. Application Data
(60) Provisional application No. 60/176,390, filed on Jan. 13, 2000.

(51) Int. Cl. G06F 17/60; H04K 1/00; H04L 9/00

(52) U.S. Cl. 705/78; 705/74; 705/39

(57) ABSTRACT

A computer implemented technique for facilitating secure electronic transactions anonymously is presented, wherein a secure private agent establishes a client relationship with a consumer, and mediates communication between the consumer and electronic commerce sites. The secure private agent substitutes internally generated identifiers for personal details of the consumer, completes details of the transaction on behalf of the consumer, authorizes payment, and guarantees the credit of the consumer to the electronic commerce site or a payment processing agent. The secure private agent concurrently monitors internet browsing activity of the consumer and provides its services on demand, or automatically in background mode.

### CROSS-REFERENCE TO RELATED APPLICATIONS

This application claims the priority of Provisional Application No. 60/176,390, filed Jan. 13, 2000.

### BACKGROUND OF THE INVENTION

1. Field of the Invention

This invention relates to the execution of electronic transactions. More particularly this invention relates to the use of a secure agent to protect sensitive information belonging to a party of a remote transaction that is conducted electronically over an insecure channel.

2. Description of the Related Art

Today shoppers, merchants and credit card issuers engaging in electronic commerce over the internet risk being victimized by fraud, and are likely to become involved in disputes resulting from unsuccessful transactions. Shoppers incur the additional risk of unauthorized use of their personal data by merchants and electronic intermediaries. These factors, and the general reluctance of many potential shoppers to expose sensitive identifying information to the internet represents a large potential loss of revenue for merchants and credit card issuers. They are realistic reasons for discomfort and concern on the part of potential shoppers. Such difficulties continue to hinder the wide acceptance and use of electronic commerce, and to slow the growth of the electronic commerce industry.

Numerous online payment methods have been proposed to handle the problems of managing secure and non-repudiated internet payment transactions. Most attempt to replace the credit card as a payment mechanism with some alternative mechanism. This usually requires a network of merchants, which would support such methods and accept an alternate form of payment. Consumers desiring to participate must trouble to establish a relationship with the operator of such a network.

Furthermore, with existing interfaces to electronic commerce sites, consumers find it frustrating to continually reenter personal details, each time they buy, or register with an electronic commerce site or service.

A credit card system is proposed in the document WO 99/49424, which has the added feature of providing limited use credit card numbers and optionally limited use cards. The system is proposed to have application in “card remote” transactions such as by telephone or via the internet in order to prevent fraud. The system has a number of enhancements, including encryption.

It is envisaged that a master credit card number is allocated to a credit card holder, along with a plurality of limited use credit card numbers, which optionally can be limited by other conditions, such as the value of the transaction, a certain number of transactions, or an aggregate value of a series of transactions. Once the conditions have been violated, the credit card number is canceled, invalidated, or otherwise deactivated. The master credit card number never need be revealed by the credit card holder while conducting a remote transaction.

This arrangement has the disadvantage in that the burden of managing a limited use card is placed on the cardholder or customer. The cardholder is thus exposed to the complexity of dealing with these identifiers, which is tedious and may be prone to error. As disclosed the limited use cards are actually issued to a particular cardholder. The limited use number is managed by deactivation by the system.

In U.S. Pat. No. 5,883,810 it is proposed to facilitate electronic commerce by requiring institutions, such as banks or certifying authorities, to issue electronic commerce cards to customers under a permanent customer account number. This type of electronic commerce card is a new type of card for the issuer's information systems to support. It requires issuing and registration to the customer base of the issuing institution, which is an additional administrative burden beyond that required to support existing types credit cards. Each time a customer desires to conduct a transaction, he must first undertake to contact the issuing institution and request a transaction number for a single transaction. This temporary transaction number is associated with the permanent account number by the issuing institution. The customer receives the number and submits it to the merchant as a proxy number. While this arrangement is relatively secure, and transparent to the merchant, it does pose considerable inconvenience to the customer.

A particularly ambitious solution, developed with the strong support of the owners of major credit brands, Visa^{SM} and MasterCard^{SM}, is the Secure Electronic Transaction (SET). This is a theoretically complete solution for the problems relating to confidential use of credit cards over the internet, but has apparently been too complex to implement on a large scale.

Thus there remains an unmet need for an electronic commerce facility, such that consumers are enabled to make purchases safely, without disclosing personal information or financial details to merchants. Provision of such facilities will enable the growth of electronic commerce, and remove a significant obstacle to the commercial use of the internet.

### SUMMARY OF THE INVENTION

It is therefore a primary object of some aspects of the present invention to improve the ease and safety of electronic commerce for consumers.

It is another object of some aspects of the present invention to enable consumers to participate in electronic transactions over an insecure channel without exposing confidential information to the merchant and to preserve anonymity.

It is still another object of some aspects of the present invention to facilitate electronic commerce for a consumer in a manner which is transparent to the merchant.

It is yet another object of some aspects of the present invention to facilitate electronic commerce without imposing inconvenience and administrative burden on customers, credit card issues, and credit card transaction processors.

It is a further object of some aspects of the present invention to provide a flexible system of secure electronic commerce that is able to adapt to a variety of account numbering conventions.

These and other objects of the present invention are attained by the provision of a computer implemented trusted third party, hereinafter referred to as a “secure private agent”, acting as an agent for the customer in a manner which is transparent to the merchant as well as the consumer. The secure private agent automatically monitors communications across a data network, which may be the internet, between the customer and an electronic site, either as a client application in the customer's computer, or residing elsewhere as a server application in the data network. The customer is identified to the secure private agent by a private identifier, which can be in any form agreed upon between the customer and the secure private agent. Once the customer has been authenticated, the secure private agent generates a proxy identifier, which may be a virtual credit card number, but can be any form of payment identification acceptable to the electronic commerce site. The proxy identifier need never reach the customer, and in general the customer is unaware of it. The actual identifier, e.g. account number, of the customer is never revealed to the electronic commerce site, thus preserving customer anonymity.

In many commercial applications, the activity space, that is the universe of available account identifiers, is limited. For example a small credit card company could be assigned a relatively narrow range of credit card numbers. As the secure private agent takes on the burden of providing unique identifiers, it deals with the issues of expiration and reuse of the identifiers, in contrast with other systems of anonymous electronic transactions, which impose this burden on the credit card issuers.

In some embodiments the customer need not even have an account with the electronic commerce site or with a credit card company. In these embodiments the secure private agent guarantees payment, and translates a private user identity into an identifier acceptable to any other party to a transaction. The secure private agent can serve the consumer as an intermediary in areas outside the traditional scope of the credit card industry.

The arrangement according to the invention is flexible as to the type of transactions with which the secure private agent can become involved. In some embodiments the party transacting business with the customer need not be a conventional e-commerce participant. In such cases, the secure private agent communicates with the other party using means other than an electronic data network. Examples of such transactions include private auctions, commodity transactions, securities transactions, specialized foreign currency markets, and the like, where it is desirable to preserve customer anonymity.

In some preferred embodiments, the secure private agent executes the payment instructions of the consumer, and arranges to pay the merchant against a private credit balance between the trusted third party and the consumer, a commercial credit card authorization, or other conventional payment mechanism which can be effected via the internet.

In other preferred embodiments of the invention the secure private agent includes client software. The client software, both in a client version and in a clientless version, is enabled by a simple login procedure which automatically causes it to execute in cooperation with the consumer's browser as a plug-in module or a proxy. Preferably the secure private agent is not required to be downloaded and installed during each use.

In some preferred embodiments of the invention the client software, both in a client version and in a clientless version, is enhanced by the inclusion therein of an automatic form filler system which spares the consumer from completing tedious forms that may be required at the electronic commerce World Wide Web sites of vendors.

In some preferred embodiments of the invention the client software is further enhanced by the provision of a unified procedure for entering electronic commerce World Wide Web sites. The client software in these preferred embodiments enables the user to register, and reenter password protected electronic commerce World Wide Web sites, without the burden of remembering large numbers of user names and passwords.

According to preferred embodiments of the invention, the secure private agent is also of benefit to credit card issuers. The secure private agent manages the execution of the transaction. Unlike traditional payment solutions, the activities of the secure private agent place the credit card issuer in the advantageous position of being aware of the existence of a valid transaction, before the transaction details reach the merchant and are processed in the credit card financial network.

The invention provides a computer implemented method of conducting secure electronic commerce, in which a secure private agent authenticates a login of a consumer onto a server of the secure private agent. The consumer is registered with the secure private agent, and the secure private agent is in possession of personal details of the consumer, which may include a credit card number. The secure private agent intercepts a communication between the consumer and an electronic commerce site, which includes a static identifier of the consumer that is transmitted between the consumer and the electronic commerce site.

According to an aspect of the invention, the method includes establishing a credit account between a fund controlled by the secure private agent on behalf of the consumer, and guaranteeing a payment by the consumer to the electronic commerce site from the credit account.

According to an aspect of the invention, the secure private agent further performs the steps of generating an identifier that links the consumer to a current transaction between the consumer and the electronic commerce site, and providing the identifier to the electronic commerce site.

According to a further aspect of the invention, the identifier is substituted by the secure private agent for an actual identifier of the consumer. The actual identifier may be a credit card number, a debit card number, a bank account number, or a payment card number.

According to a further aspect of the invention, the identifier is preallocated.

According to another aspect of the invention, the identifier is reused, and is subsequently associated with a second transaction of another consumer.

According to a further aspect of the invention, the secure private agent monitors access of the electronic commerce site by the consumer.

According to another aspect of the invention monitoring is accomplished by executing a client application of the secure private agent in a communication device of the consumer.

According to another aspect of the invention monitoring is accomplished by executing a proxy server application of the secure private agent.

According to still another aspect of the invention, the secure private agent automatically logs the consumer into the electronic commerce site.

According to an additional aspect of the invention, the secure private agent automatically submits information relating to the current transaction to the electronic commerce site.

According to another aspect of the invention, the secure private agent provides a guarantee in favor of the electronic commerce site of an obligation that is incurred by the consumer in the current transaction.

The invention provides a computer implemented method of conducting secure electronic commerce, comprising the steps of associating a proxy server with a browser of a party to a transaction, wherein the browser is in communication with an electronic commerce site, authenticating an identity of the party, modifying files that are provided by the electronic commerce site such that command instructions carried in the files are routed through the proxy server, generating an identifier that links the party to a current transaction between the party and the electronic commerce site, and providing the identifier to the electronic commerce site.

According to another aspect of the invention, the method includes the step of automatically completing transaction details that are required by the electronic commerce site.

Still another aspect of the invention includes the steps of establishing a communications channel between the proxy server and a payment processing agent, and authorizing a payment by the party to the electronic commerce site to the payment processing agent.

In another aspect of the invention the provision of an identifier to the electronic commerce site comprises receiving a request to pre-authorize payment from a credit card facility, such as a credit card issuer, pre-authorizing the payment and memorizing the pre-authorization. The identifier provided to the electronic commerce site is a confirmation of said pre-authorizatlon which allows the account to be settled. An additional aspect of the invention includes the step of establishing a credit account with a fund controlled by the proxy server on behalf of the party, and guaranteeing the payment from the credit account.

According to an aspect of the invention, a front end client is installed in a computer of the party.

According to another aspect of the invention, the step of generating an identifier also includes substituting the identifier for a credit card number of the party.

The invention provides a computer system for conducting electronic commerce, comprising a front end client application, executing on a computer of a user, a back-office logic application linked to a transaction processor, a back-end gateway application, linked to the user, the front end client application, and the back-office logic application via a data network, and communicating with a commerce site. The back-end gateway application intercepts communications between the user and the commerce size. Responsive to a static identifier that is directed in a first communication by the user to the commerce site, the back-end gateway application blocks the first communication. The back-office logic application generates a virtual identifier, and the back-end gateway application communicates the virtual identifier to the commerce site in a second communication. The back-office logic application communicates an actual identifier to the transaction processor in a third communication.

According to still another aspect of the invention, the front end client application and the back-end gateway application execute in the computer of the user.

According to another aspect of the invention, the back-end gateway application and the back-office logic application execute on at least one server that is linked to the data network.

According to an additional aspect of the invention, the virtual identifier is a credit card number.

According to an aspect of the invention, the actual identifier is a credit card number.

The invention provides a computer software product, comprising a computer-readable medium in which computer program instructions are stored, which instructions, when read by a computer, cause the computer to perform the steps of associating a proxy server with a browser of a party to a transaction, wherein the browser is in communication with an electronic commerce site, authenticating an identity of the party, modifying files that are provided by the electronic commerce site such that command instructions carried in the files are routed through the proxy server, generating an identifier that links the party to a current transaction between the party and the electronic commerce site, and providing the identifier to the electronic commerce site.

According to yet another aspect of the invention, the computer Further performs the step of automatically completing transaction details that are required by the electronic commerce site.

According to still another aspect of the invention, the computer further performs the steps of establishing a communications channel between the proxy server and a payment processing agent, and authorizing a payment by the party to the electronic commerce site to the payment processing agent.

According to another aspect of the invention, the identifier is substituted for a credit card number of the party.

The invention provides a computer software product, comprising a computer-readable medium in which computer program instructions are stored, which instructions, when read by a computer, cause the computer to perform the steps of intercepting a communication between a browser of a party to a transaction and an electronic commerce site, authenticating the identity of the party, receiving an identifier that links the party to a current transaction between the party and the electronic commerce site, and providing the identifier to the electronic commerce site.

According to an aspect of the invention, the computer further performs the step of automatically completing transact on details that are required by the electronic commerce site.

According to another aspect of the invention, the identifier is substituted for a credit card number of the partv.

### BRIEF DESCRIPTION OF THE DRAWINGS

For a better understanding of these and other objects of the present invention, reference is made to the detailed description of the invention, by way of example, which is to be read in conjunction with the following drawings, wherein:

FIG. 1 schematically illustrates an arrangement of electronic commerce employing a secure private agent in accordance with some preferred embodiments of the invention;

Fir. 2 is a block diagram illustrating details of the arrangement shown in FIG. 1;

FIG. 3 illustrates an arrangement of electronic commerce employing a secure private agent in accordance with an alternate embodiment of the invention;

FIG. 4 is a flow chart illustrating the operation of a clientless embodiment of the invention;

FIG. 5 is a flow chart illustrating the processing of a particular transactional event in the flow chart of FIG. 4;

FIG. 6 is a flow chart illustrating the processing of information received in preferred embodiments of the invention by a commerce site and a credit card issuer; and

FIG. 7 is a flow chart illustrating the operation of a client version of the invention; and

FIG. 8 is a block diagram illustrating details of an alternate embodiment of the invention generally employing the technique illustrated in FIG. 1.

### DESCRIPTION OF THE PREFERRED EMBODIMENT

In the following description, numerous specific details are set forth in order to provide a through understanding of the present invention. It will be apparent however, to one skilled in the art that the present invention may be practiced without these specific details. In other instances well known circuits, control logic, and the details of computer program instructions for conventional algorithms and processes have not been shown in detail in order not to unnecessarily obscure the present invention.

The secure private agent (SPA) system is an advanced system for protecting on-line internet shopping and payment transactions. The system is offered for credit-card issuers, which use it to monitor legitimate card usage and thus detect unauthorized use, including fraud. The system offers two methods of monitoring legitimate use by cardholders: the first is by way of a software agent, which is installed on the cardholder's desktop, and the second is by means of a proxy service. The software agent, as realized in server and client applications, may be distributed on computer readable media for installation in appropriate computers.

While the preferred embodiments are disclosed with reference to credit card transactions, this invention is not restricted to use with credit cards, and is applicable to many forms of transactions which could be completed electronically, for example, auctions, gambling, and anonymous e-mail services.

Software Agent (Client Mode)

In this mode of operation, the agent on the cardholder's desktop monitors browser's activity to identify and act upon execution of internet payment transactions. The user's experience is identical to normal surfing, enhanced by additional agent services, which are offered to smooth the purchasing experience (e.g. form filling service).

Basically, the client mode software agent combine two SPA modules known as front end client (FEC) and back end gateway (BEG). It offers an independent user interface to the cardholder and the monitoring logic that communicates with the back office logic (BOL) and the electronic commerce site (ECS).

The client mode utilizes local user computing resources, and supports strong authentication of the user (e.g. by means of combining user and hardware identification). Authentication is preferably accomplished by the techniques disclosed in our co-pending application No. 60/187,353, Filed Mar. 6, 2000, which is incorporated herein by reference. Some embodiments of the client mode require installation of an agent and a configuration step with respect to the credit-card issuer which is running the SPA server side service. In other embodiments the client application can be executed from stand-alone portable computer readable media, for example floppy diskettes, CDs and the like.

Proxy Service (Clientless Mode)

In this scenario, nothing is installed on the user's desktop, and thus the cardholder can use the system anywhere, from any desktop or internet appliance, and using any Web browser. Instead, the user is asked to surf to the credit-card issuer site and logon to the secure payment service. This action results in the presentation of a form, which allows the user to enter the URL of the electronic commerce site that he wants to shop. The user can enter any site, including those hosting search engines, and surf to the preferred shopping site.

The act of logging into the secure payment service and surfing from it allows the system to route the communication between the user's browser and the internet (essentially the electronic commerce sites) through a proxy service. This service monitors the surfing activity and acts upon execution of internet payment transactions. The user's experience is similar to normal surfing, but the user enjoys the added services offered by the proxy service such as automatic form filling. A control palette is optionally displayed at the top of each browsed page to remind the user of the service and allow him to perform actions relating to the proxy service.

Basically, the proxy server is an implementation of the back end gateway, which modifies incoming electronic commerce site HTML files to route HTTP or HTTPS requests through the proxy and adds the control palette. These modified files are sent to the user's browser, which displays the control palette (front end client implementation) and the requested page information. During a payment transaction the Proxy interacts with the back office logic, in order to implement the SPA payment process.

The clientless mode uses central computing resources and high communication bandwidth (depending on the number of concurrent users). It can, however, be physically placed in a different location from the back office logic. By the nature of this mode of operation no installation or configuration is required, and thus the enhanced usage flexibility for the users.

System Architecture.

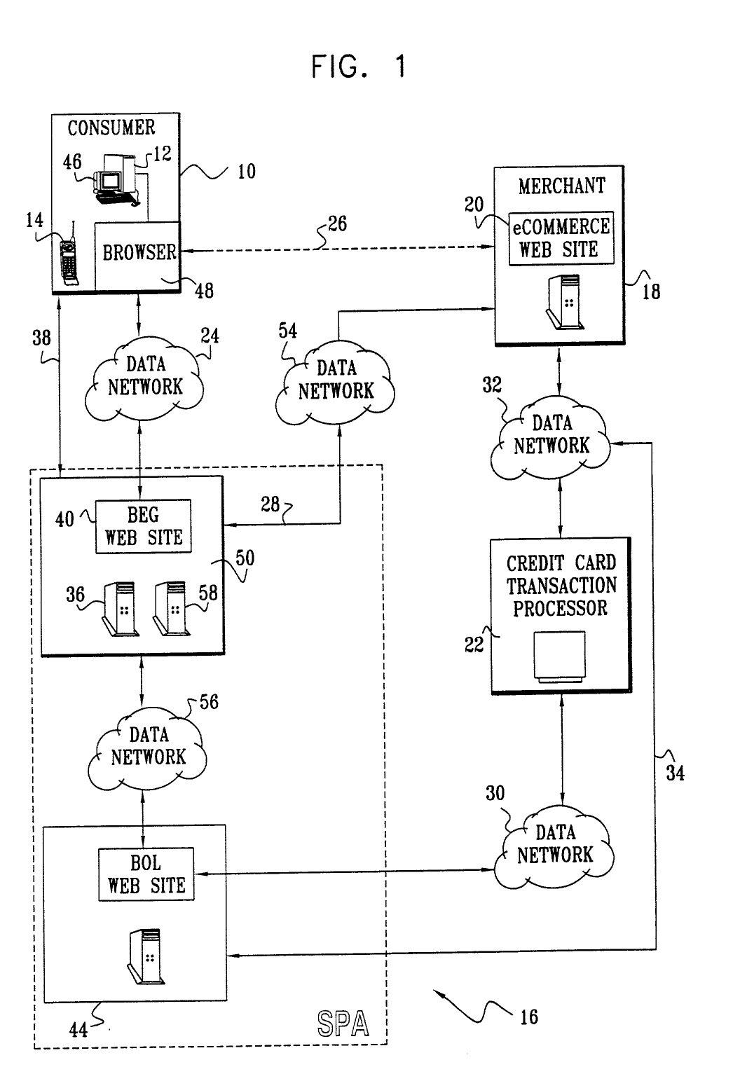

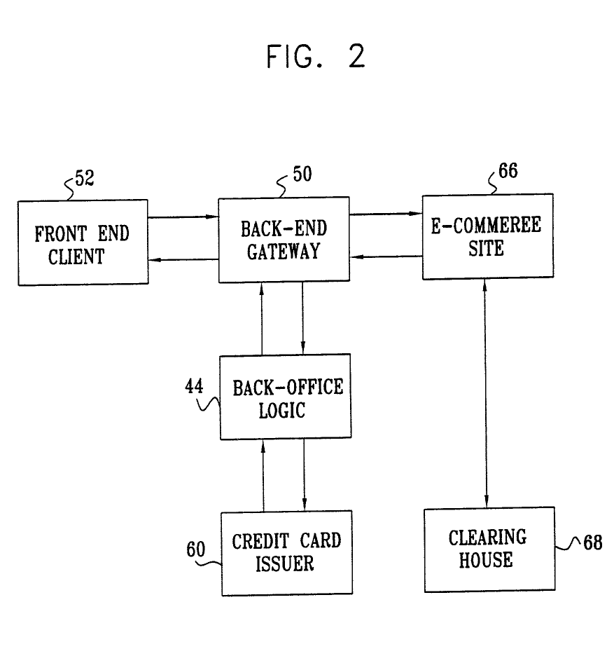

Turning now to the drawings, and in particular to FIG. 1 a consumer 10 desiring to engage in electronic commerce is provided with a communication device 12, and optionally with a telephone device 14. The communication device 12 is preferably a personal computer equipped with a modem, but could be any suitably programmed wireless device, a personal digital assistant, or the like. The telephone device 14 can be a cellular telephone, a conventional telephone, or a networking device such as a net card associated with the personal computer, or a wireless device. Other parties to electronic commerce according to preferred embodiment of the invention include a secure private agent 16, a merchant 18 having an electronic commerce site 20, and a credit card transaction processor 22.

The consumer 10 normally communicates with elements of the secure private agent 16 via the Internet on a secure or insecure internet channel 24. Encryption of the internet communications by known methods may be employed. The techniques for establishing interparty communication via the internet are well known, and will not be further described. As will be explained in greater detail hereinbelow, the consumer 10 and the merchant 18 communicate via the internet on a channel 26. In some preferred embodiments of the invention the channels 24, 26 are wireless channels. During an electronic commerce transaction, a communication channel 28 is established via the internet between the secure private agent 16 and the merchant 18. An additional communication channel via data network 30 may be established between the secure private agent 16 and the credit card transaction processor 22, preferably via a private network. In some embodiments the secure private agent 16 can communicate directly with a private financial data network 32 over the channel 34.

Prior to conducting a transaction, it is necessary that the consumer 10 establish a relationship with the secure private agent 16. This can be accomplished by registration via the internet. The consumer 10 establishes contact with the World Wide Web site of the secure private agent 16 by initiating the channel 24 and provides the information needed by the secure private agent 16. Alternatively, the registration can be accomplished by directly accessing the server 36 of the secure private agent 16 via a telephone channel 38. In the event the consumer is reluctant to use even a secure internet site, it is possible to register with the secure private agent 16 by a completed application form transmitted by mail or courier, or by using a prepaid card that can be currently be bought in “virtual” shops.

The registration process using the internet will now be disclosed in further detail.

1. The consumer 10 enters the World Wide Web site 40 of the secure private agent 16.

2. At the World Wide Web site 40 he is presented with the terms and conditions which must be agreed to in order to become a registered client of the secure private agent 16.

3. After agreeing with the terms and conditions the consumer 10 is requested to provide personal details, including his credit card number.

4. The personal details are passed to the secure private agent 16, employing either the channel 24 or the telephone channel 38. They are saved in a secure database system residing in a server 42 of the back office logic 44.

Registration using a pre-paid card is accomplished as follows.

1. The consumer 10 enters the World Wide Web site 40 of the secure private agent 16.

2. At the World Wide Web site 40 he is presented with the terms and conditions which must be agreed to in order to become a registered client of the secure private agent 16.

3. After agreeing with the terms and conditions the consumer 10 is requested to insert the identification number of the prepaid card and optionally to supply his credit card number. If the consumer 10 declines to supply his credit card number he remains anonymous to the secure private agent 16 as well. An anonymous client has privileges to spend money up to the limit specified in his prepaid card, and to submit his credit card number and other personal details to the secure private agent 16 and thereby register an identified client.

The registration process using a telephone channel is as follows.

1. The consumer 10 calls the telephone number of the secure private agent 16.

2. Vocal contact is established with a customer sales representative or an interactive voice response system (IVR) answers the customer. The consumer 10 is verbally presented with the terms and conditions which must be agreed to in order to become a registered client of the secure private agent 16. Normally the terms and conditions are supplied in writing or electronically afterward.

3. The consumer 10 then supplies personal details, including his credit card number either verbally, or by other conventional methods such as mail, facsimile, or telephone keypad entry. Once the personal details are received, the consumer 10 may begin participating in electronic commerce immediately, using the facilities of the secure private agent 16.

Following registration by any of the above noted methods, a number of post-registration events routinely occur.

1. The consumer 10 now has an established personal account with the secure private agent 16. He is furnished some account information, such as a user name and temporary password. Processes are initiated in the back office logic 44 to authenticate the consumer 10 when he next logs in.

2. Once the consumer 10 has logged in to the server 42 via the server 36, he may configure his account, and can set up financial rules for transactions. Examples of such rules are:

a) Purchase up to a limit of X monetary units (wherein X is an arbitrary number). When a legal transaction is executed, the appropriate amount is charged to the credit card of the consumer 10, and his account at the secure private agent 16 will be increased by an equivalent amount.

b) Purchase up to a limit of X monetary units whenever the account at the secure private agent 16 has a balance of less than Y monetary units. When a legal transaction is executed, the appropriate amount is charged to the credit card of the consumer 10, and his account at the secure private agent 16 will be increased by an equivalent amount.

c) Sell up to a limit of X monetary units. An equivalent amount will be credited to the credit card of the consumer 10, while simultaneously adjusting the balance of the account at the secure private agent 16.

d) Sell up to a limit of X monetary units whenever the account at the secure private agent 16 has a balance of more than Y monetary units. An equivalent amount will be credited to the credit card of the consumer 10, while simultaneously adjusting the balance of the account at the secure private agent 16.

The procedure for making a purchase follows, and in some preferred embodiments, in the course of the procedure, the secure private agent 16 mediates information flowing to and from the consumer 10 via the internet. It is possible to configure the secure private agent 16 to mediate all information that could affect the ability of the electronic commerce site 20 to collect information about the consumer 10. This mediation may protect against the disclosure of such information as the internet Protocol (IP) address of the consumer 10, his personal data and financial information, and cookies stored in the communication device 12.

1. The secure private agent 16 initiates the process of mediating information flow to and from the consumer 10 via the internet. While the secure private agent 16 is active, information flow between the consumer 10 and a selected electronic commerce site 20 occurs via the channel 24, the server 36, and the channel 28 rather than directly via the channel 26.

2. The consumer 10 selects a merchant 18, and accesses its electronic commerce site 20. Whether this is done from a previously bookmarked entry, a list, or by browsing, the secure private agent 16 concurrently tracks World Wide Web size accesses of the consumer 10, and user's surfing path and protects the user's privacy by acting as a gazeway.

3. The consumer 10 follows the shopping procedures of the electronic commerce site 20, selecting any accepted mode of payment he chooses. The secure private agent 16 may be configured to mediate payment procedures other than conventional credit cards.

4. Once all desired goods or services are in the “shopping cart”, the consumer 10 proceeds to the payment page of the electronic commerce site 20.

5. At this point, the secure private agent 16 can optionally complete the transaction details automatically. It can provide all necessary details concerning the consumer 10, including such matters as a standard delivery address, preferred mode of shipment, insurance options, and the like. The consumer 10 is requested by the secure private agent 16 whether he wishes to elect the automatic completion option.

6. In the matter of customer identification, either the consumer 10 or the secure private agent 16 (if the automatic completion option was selected) supplies a static identifier that activates the secure private agent 16. The static identifier could be a predetermined temporary number or an actual credit card number. The actual credit card number of the consumer 10 is never provided to the electronic commerce site 20.

7. The consumer 10 confirms the details of the transaction by activating a “BUY” or similar command button of the electronic commerce site 20. The secure private agent 16 then requests the consumer 10 to verity the transaction and optionally its value. This may be done by activating a pop-up window on the display 46 of the communication device 12.

8. After the approval of the consumer 10, the secure private agent 16 sends the appropriate information, replacing the credit card number of the consumer 10 with an assigned identifier provided by of the secure private agent 16. The identifier can be generated in several ways, including on-the-fly, or in some embodiments by calculation, or by allocation from a list, or from a range of values. The credit balance and status of the consumer 10 can be checked in real time at each transaction according to the privileges of the account of the consumer 10. In some embodiments the information is sent to the electronic commerce site 20, in which case the transaction appears to have been executed by the consumer 10 and the role of the secure private agent 16 is completely transparent to the merchant 18. The merchant 18 sees the identifier of the secure private agent 16 as a credit card number, and processes this in the usual manner. Payment is guaranteed by the secure private agent 16, either directly, or via a conventional credit card issuer.

The secure private agent 16 can employ a wireless application protocol (WAP) based technology and business mode, along with its supporting back-office infrastructure. This technology enables the operation of a specialized role in electronic commerce. As disclosed above the services of the secure private agent 16 are utilized concurrently with a transaction in electronic commerce.

In some preferred embodiments of the invention, the secure private agent 16 executes in the browser 48 of the consumer 10, or in its computing environment. In other preferred embodiment of the invention software of the secure private agent 16 can be provided on a medium, as is well known in the art, and permanently installed in the communication device 12, in which case it may offer additional services and capabilities.

Architecture of Clientless Version.

Referring now to FIGS. 1 and 2, the architecture of a clientless version of the secure private agent 16 is now disclosed in further detail. The communication device 12 of the consumer 10 communicates with a major component, the back-end gateway 50 through the channel 24, which in this embodiment is preferably the internet using the HTTPS protocol for security. It relays requests of the consumer 10, and receives information as part of the interaction with the consumer 10.

The back-end gateway 50 preferably resides on the server 36. It interacts directly with the front-end client 52 and the browser 48. In some embodiments the interaction of the back-end gateway 50 with the browser 48 is mediated by a front end client, which is an interface carried in an HTML document or by a Java applet which is downloaded from the back-end gateway 50 to the browser 48. The back-end gateway 50 concurrently interacts via a data network 54 with the electronic commerce site 20 which is currently being accessed by the consumer 10. The data network 54 is preferably the internet. The back-end gateway 50 is also linked with the back office logic 44 via a data network 56, which is preferably the internet. The role of the back-end gateway 50 is to monitor the activities of the consumer 10 on the internet, and to intercept and mediate information flow between the consumer 10 and the electronic commerce site 20. As the consumer 10 accesses various sites of the World Wide Web, the back-end gateway 50 identifies situations in which the services of the secure private agent 16 are appropriate or mandatory. In some preferred embodiments in which the communication device 12 is a wireless device, it is desirable that the back-end gateway 50 execute on a wireless application protocol server 58, which can be integral with the facilities of the secure private agent 16, or remotely located. The wireless application protocol server 58 translates the content of World Wide Web hypertext markup language (HTML) files into Wireless Markup Language (WML), a close relationship between the back-end gateway 50. Thus the wireless application protocol server 58 ultimately enhances the functionality of the secure private agent 16 by providing mobile channels of communication.

The back office logic 44 manages the information relating to the transactions of the consumer 10, and information of the consumer 10 as well. It manages the user profile and account of the consumer 10, and handles the transaction authentication and logging. The back office logic 44 communicates these data as needed to the back-end gateway 50. The back office logic 44 also communicates with the credit card transaction processor 22 to complete the transaction authorization over a data network 30, which is preferably a private network. In some embodiments the back office logic 44 can also communicate directly with a private financial data network 32 using the channel 34. In some embodiments the credit card transaction processor 22 can be the credit card issuer 60.

Architecture of Client Version.

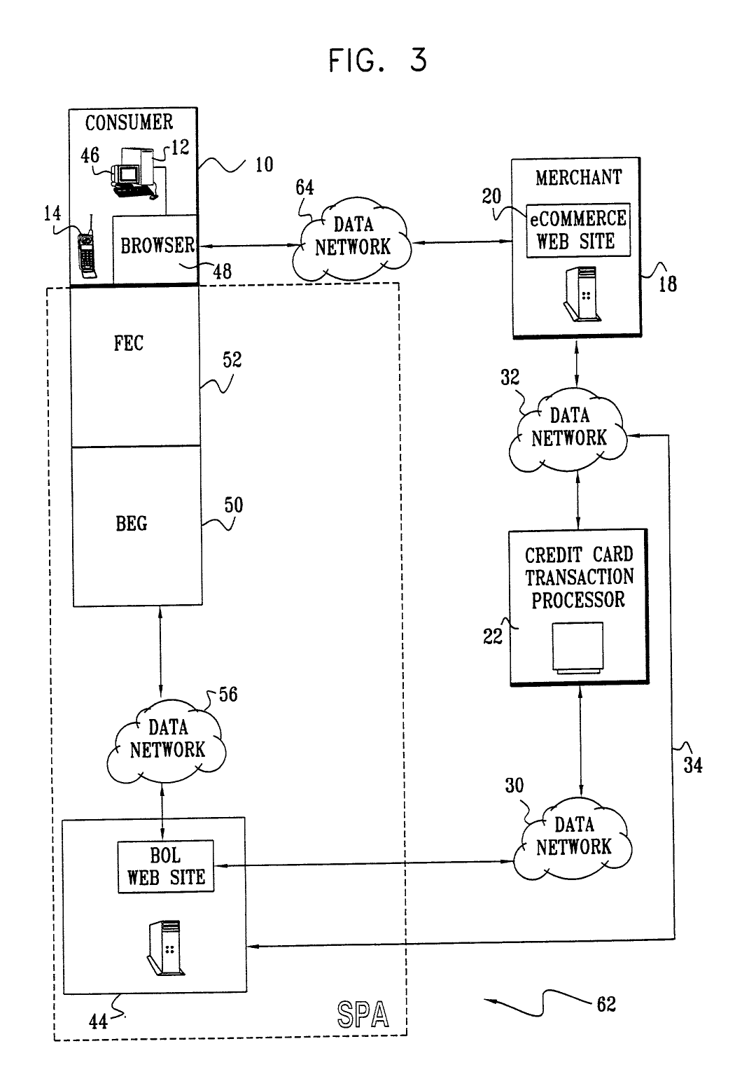

Referring now to FIG. 3 the architecture of a client version of the secure private agent 62 is now disclosed in further detail. There are three major components of the secure private agent 62. First, on the client side, the front-end client 52 and the back-end gateway 50 are coresident in the computer system of the consumer 10 together with the browser 48 of the communication device 12. The front-end client 52 controls some of the activity of the browser 48, and interacts with the consumer 10. The front-end client 52 communicates extensively with the back-end gateway 50 using conventional techniques of interprocess communication, and can even share the same process in some embodiments. It relays requests of the consumer 10, and receives information as part of the interaction with the consumer 10. The front-end client 52 also provides the user interface for the services of the secure private agent 62.

The back-end gateway 50 interacts directly with the front-end client 52 and the browser 48. Using the communication facilities of the communication device 12 and the data network 64, the back-end gateway 50 also interacts with the electronic commerce site 20 that which is currently being accessed by the consumer 10. The data network 64 is preferably the internet. The back-end gateway 50 communicates with the back office logic 44 via the data network 56, which is preferably the internet. The role of the back-end gateway 50 is to monitor the activities of the consumer 10 on the internet, and to intercept and mediate information flow between the consumer 10 and the electronic commerce site 20. As the consumer 10 accesses various sites of the World Wide Web, the back-end gateway 50 identifies situations in which the services of the secure private agent 62 are appropriate or mandatory. In some preferred embodiments in which the communication device 12 is a wireless device, it is desirable that the back-end gateway 50 communicate with the back office logic 44 using a wireless application protocol, which translates the content of World Wide Web hypertext markup language (HTML) files into Wireless Markup Language (WML). The ability of the back-end gateway 50 to operate in various portable versions of the communication device 12, and to utilize the wireless application protocol enhances the functionality of the secure private agent 62.

The back office logic 44 functions in the same manner as disclosed with respect to the clientless version. It manages the secure private agent information, performs authentication, and records transactions. It also provides translations services regarding the virtual identities. This disclosure is therefore not repeated here.

Elements Common to Client and Clientless Versions.

It is helpful to better understand the invention if three additional elements are discussed in further detail. These elements are participants in the transaction process, but are independent of the secure private agent.

The electronic commerce site, shown in FIG. 2 as electronic commerce site 66, has no special role in the operation of the secure private agent 16. It performs its conventional functions, e.g., serving Web pages and processing the usual communication messages. In some preferred embodiments the electronic commerce site 66 is not aware of the involvement of the secure private agent 16 in a transaction. In other preferred embodiments of the invention, the electronic commerce site 66 can optionally affiliate with the secure private agent 16 and offer facilities of the secure private agent 16 that facilitate its operations in electronic commerce.

The credit card issuer 60 is an entity that issues credit cards to the secure private agent 16. These credit cards are allocated to clients of the secure private agent 16, such as the consumer 10, and are used during purchase or payment transactions which are managed by the secure private agent 16. The credit card issuer 60 may also be involved in the authorization process as part of its usual function in processing a credit card payment. As a fraud prevention measure, the back office logic 44 interacts with the credit card issuer 60 in order to set up the authorization.

The clearing house 68 (FIG. 2) plays a conventional role in transactions mediated by the secure private agent 16. It accepts credit card payment information relating to transactions from the electronic commerce site 66 and clears those transactions. It does so by communicating with the credit card issuer 60. Conventionally the electronic commerce site 66, the clearing house 68, and the credit card issuer 60 communicate over private data networks or channels, shown as the financial data network 32. The charges are forwarded to the credit card issuer 60, which maintains the status of the credit card involved in the transaction. The clearing house 68 is totally unaware of the existence of the secure private agent 16 or its involvement in the transaction.

In some embodiments of the invention in which the secure private agent 16 assumes responsibility for payment, accounts are periodically reconciled between the credit card issuer 60 and the secure private agent 16. The reconciliation process is mainly a responsibility of the back office logic 44.

There are many variations in the implementation of the secure private agent 16. These implementations may differ in the location where specific functions are executed, the nature of the services which are provided by the secure private agent 16, the degree of automation of the secure private agent 16, as well as many other details.

Operation of Clientless Version.

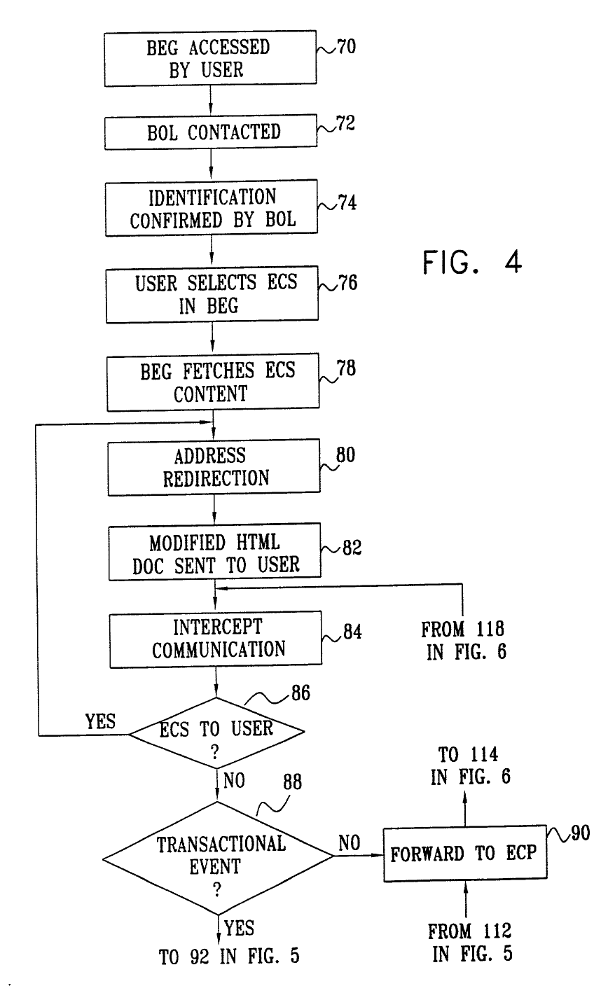

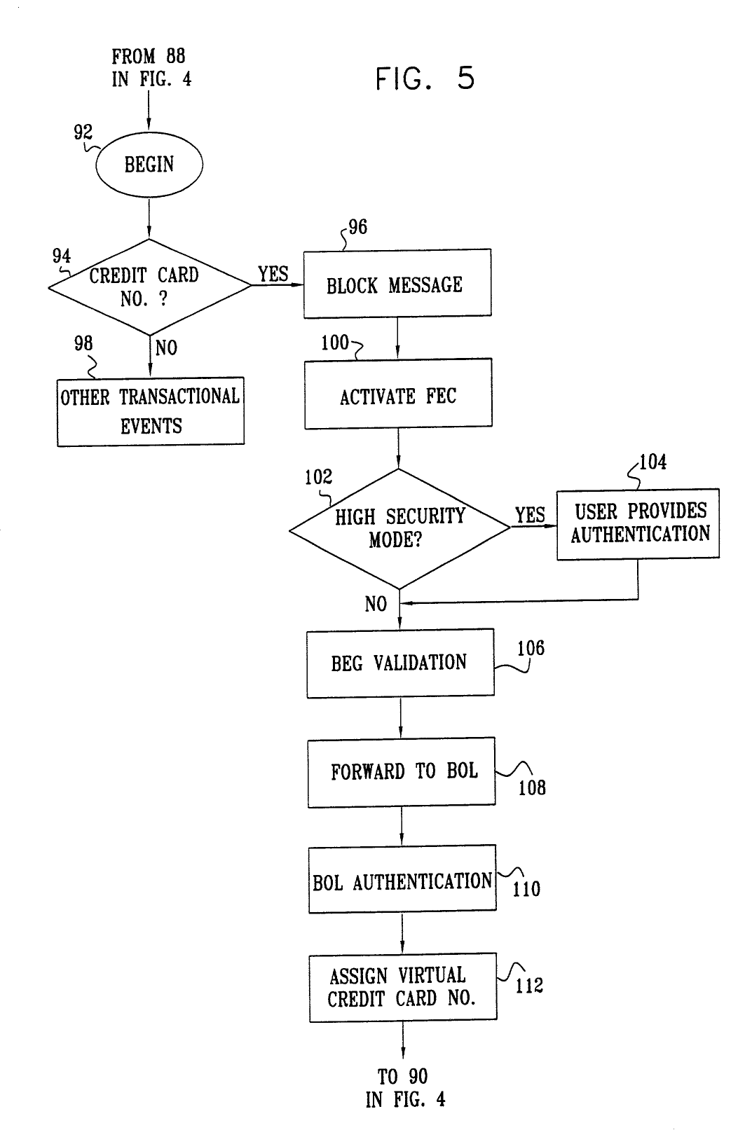

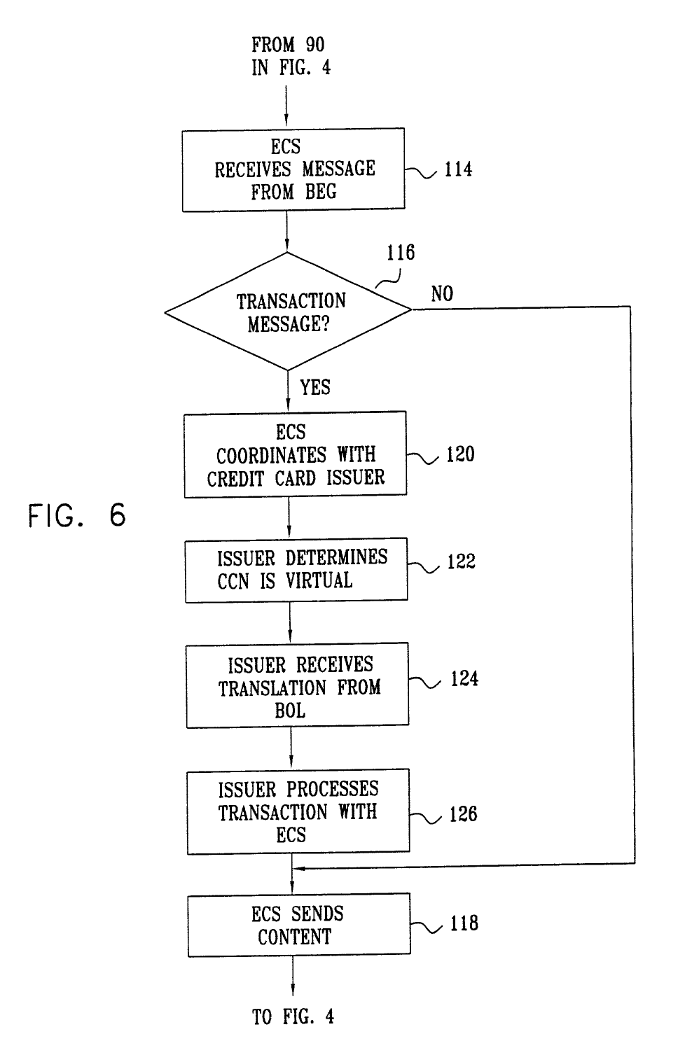

The use of the arrangement shown in FIG. 1 is explained in terms of a clientless option with reference to FIGS. 4 and 5. It is understood that in this version the back-end gateway 50 has been installed as a World Wide Web service. While identities are explained in terms of credit card numbers, other identifiers can be employed, such as debit card numbers, account numbers, various personal identification numbers, or any other billing identifier. The identifiers could also be e-mail addresses, telephone numbers, data service numbers, and the like. The identities can be limited to use in a single transaction, or optionally can be employed for multiple transactions, or can be valid for a predetermined time interval.

At step 7C the consumer 10 accesses the URL of the back-end gateway 50 using the browser 48, and optionally logs into the back-end gateway 50 using an authentication procedure, which may be a username and password. The back-end gateway 50 optionally downloads an HTML document that directs the input of the consumer 10, or a Java applet that manages the consumer's input. At step 72 the back-end gateway 50 communicates with the back office logic 44, requesting identification of the consumer 10. Next, at step 74, the back office logic 44, which may be located either in the server of the back-end gateway 50 or in a different physical location, authenticates the information of the consumer 10. Having successfully established communication with the back-end gateway 50, at step 76 the consumer 10 selects a desired electronic commerce site 20 using the appropriate service page of the back-end gateway 50. At step 78 communication is established between the electronic commerce site 20 and the back-end gateway 50, and the back-end gateway 50 fetches the content of the electronic commerce site 20, generally retrieving the content as an HTML or a WML document. Next, at step 80, the back-end gateway 50 substitutes its own IP address for that of the electronic commerce site 20 in the HTML document. At step 82 the modified HTML document is sent to the browser 48. It will be noted that the address redirection has been accomplished by the back-end gateway 50 without need to maintain a database of documents having redirected addresses.

The consumer 10 then interacts with the electronic commerce site 20. All such communications are intercepted by the back-end gateway 50 at step 84. At decision step 86 a determination is made by the back-end gateway 50 whether the communication is directed to the electronic commerce site 20 or to the consumer 10. If the communication is intended for the consumer 10, then control returns to step 80 for address redirection.

If the communication is intended for the electronic commerce site 20, a further test is made at decision step 88 to determine if the communication qualifies as a special transactional event that requires further intervention by the back-end gateway 50. If not, it is only necessary for the back-end gateway 50 to note any URL navigation requests of the consumer 10, and to forward the communication to the electronic commerce site 20 in step 90. However, if the communication is a qualifying transactional event, then control proceeds to a sequence beginning with step 92, which is shown in FIG. 5. If at decision step 94 the consumer 10 has filled out a temporary credit card number or an actual credit care number, the back-end gateway 50 blocks the message at step 96. Otherwise, in alternate embodiments, additional transactional events may be processed in step 98, as is disclosed in further detail below. At step 100 the front-end client 52 is activated, and requests the consumer 10 to enter or confirm transaction details by presenting an HTML form or a Java form to the browser 48. At decision step 102, if a high degree of security is required, the front-end client 52 further asks at step 104 for authentication information concerning the consumer 10. In other embodiments step 104 can be omitted, since the consumer 10 had already been authenticated in step 74 (FIG. 4).

In either event the consumer 10 fills the HTML or Java form and approves the information. The information may optionally include indication of the actual credit card to be charged. The front-end client 52 receives the information and requests its authentication from the back-end gateway 50 in step 106. In some embodiments the consumer 10 can select an identity, such as a credit card number, from a list of possible identities. The front-end client 52 sends the user authentication, and in some embodiments, may send related information to the back-end gateway 50 using the browser 48 as a navigation request. The back-end gateway 50 forwards the authentication and any related information to the back office logic 44 in step 108.

In step 110 the back office logic 44 further verifies the credentials of the consumer 10. Next, in step 112, the back office logic 44 allocates a virtual credit card number as a virtual identity for the consumer 10, records the allocated virtual credit card number and the actual account number for the transaction, and returns the virtual credit card number to the back-end gateway 50.

Control then returns to step 90 (FIG. 4), at which point the back-end gateway 50 sends a message to the electronic commerce site 20. This message is similar to the message which was blocked in step 96, the temporary identity has been replaced with the virtual identity that was assigned in step 112. Control then returns to the on-going operational mode of intercepting traffic at step 84.

The behavior of the electronic commerce site 20 and the credit card transaction processor 22 in response to step 90 is shown in FIG. 6. At step 114 the message sent in step 90 is received by the electronic commerce site 20, which is indifferent to the virtual credit card number or the virtual identity. The electronic commerce site 20 considers the virtual credit card number to be an actual credit card number or identity of the consumer 10, and behaves accordingly, eventually returning appropriate content.

Next at decision step 116 a test is made to determine if the message sent in step 90 qualifies as a transaction message. If not then control proceeds directly to step 118 which is explained below.

If the test at decision step 116 is affirmative, then in step 120 the electronic commerce site 20 processes the request in a conventional manner, coordinating authorization and clearing with the credit card issuer 60. This is accomplished via any convenient form of data communication between them, and may involve the clearing house 68. In step 122 the credit card issuer 60 identifies that the submitted credit card number is a virtual identity, and in step 124, the credit card issuer 60 connects with the back office logic 44 to obtain a translation between the virtual identity and the actual identity of the consumer 10.

In some embodiments, as a result of the connection in step 124, the translation that is provided by the back office logic 44 is an identifier that simply confirms a pre-authorized transaction, and allows the account to be settled. In this case a previous communication will have occurred between the back office logic 44 and the credit card issuer 60. The pre-authorization occurs in the manner disclosed in our copending application No. 60/206,567, which is incorporated herein by reference.

In still other embodiments of step 124, the transaction associated with a virtual identity arrives at the back office logic 44 via the channel 34 (FIG. 1). The back office logic 44 translates the virtual identity to an actual identity, and sends a new transaction message back to the credit card issuer 60 via the financial data network 32. The credit card issuer 60 receives the message, which contains the actual identity of the consumer, rather than the virtual identity, processes the transaction, and returns the result via the financial data network 32 to the back office logic 44. The back office logic 44 then returns the authorization result to the e-commerce site 20 via channel 34 in a message that contains the virtual identity.

In step 126 the credit card issuer 60 processes the actual identity of the consumer 10 or the authorization result and performs conventional coordination with the electronic commerce site 20 on the basis of the virtual credit card number or identity, as if an actual credit card number or identity had been originally received at step 114. In all cases content is returned by the electronic commerce site 20 at step 118, and control returns to step 84 (FIG. 4).

Operation of Client Version.

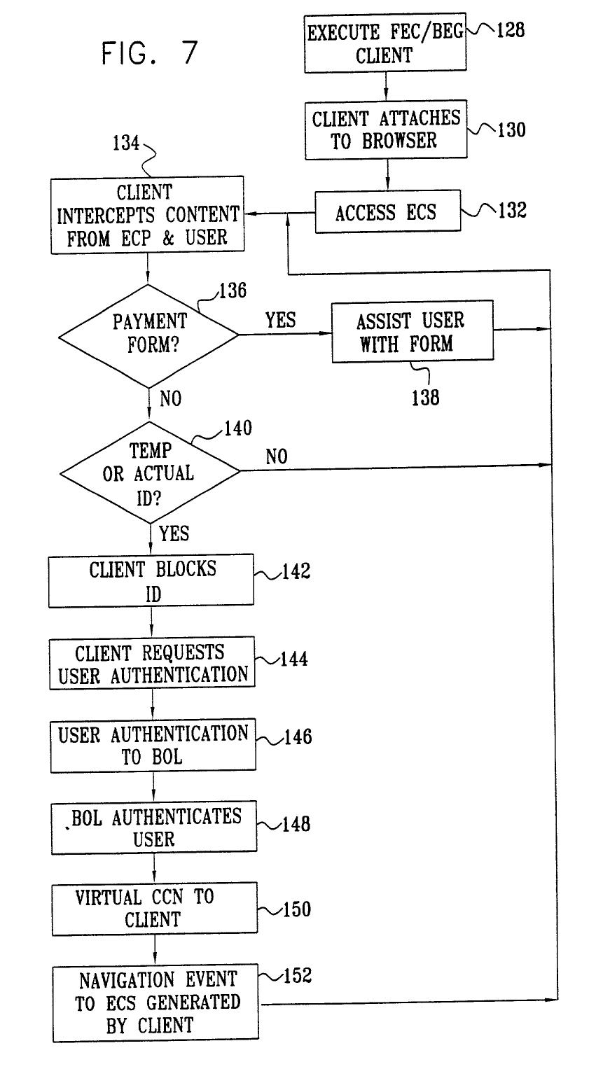

The use of the arrangement shown in FIG. 3 is explained in terms of a client version with reference to FIG. 7. It is understood that the front-end client 52 and the back-end gateway 50 are both installed as a client application on the communication device 12, which is preferably a personal computer. The back office logic 44 is installed elsewhere as a server application and is linked to the computer of the consumer 10 via the data network 56, which is preferably the internet. In initial step 128 the consumer 10 runs the client application explicitly, or the client application may auto-start upon boot or browser activation. At step 130 certain initial events occur. The client application attaches to the browser 48. The client application intercepts both navigation events generated by the browser 48, and HTML page content or similar received from the electronic commerce site 20. At step 132 the consumer 10 accesses the URL of the electronic commerce site 20 using the browser 48, and shops electronically. At step 134 the client intercepts bi-directional communication between the consumer 10 and the electronic commerce site 20, e.g. by using browser events. At decision step 136 a test is made to determine if the intercepted communication is a payment form from the electronic commerce site 20 requesting credit card or other payment information in order to bill the consumer 10. If such a payment form is intercepted then at step 138 the client application assists the consumer 10 in completing the form, or in some embodiments the client application completes the form automatically. Control then returns to step 134 at which point additional content may be requested from the electronic commerce site 20.

If the test at decision step 136 is negative, then at decision step 140 a test is made to determine if the intercepted communication includes a temporary credit card number or an actual credit card number that is being sent by the consumer 10 to the electronic commerce site 20. This communication may be provided as either an HTTP or an HTTPS message. In step 142 the navigation event is then canceled by the client application, effectively blocking the message. Instead, in step 144 the client application presents a GUI form on the display 46, requesting the consumer 10 to provide authentication information, which may be a username and password. Next, in step 146, the consumer 10 completes the GUI form, approves the entry, and the content of the GUI form is transmitted via the internet to the back office logic 44. Optionally at this point, the consumer 10 may select an actual credit card to be charged.

In step 148 the back office logic 44 authenticates the consumer 10, and then, in step 150, transmits a virtual credit card number to the client application via the internet. The back office logic 44 also maintains a record of the virtual credit card number as well as the actual credit card number that is associated with the virtual credit card number for the current transaction.

In step 152 the client application initiates a navigation event in the browser 48, which is directed to the original URL of the electronic commerce site 20, having the same parameter as the blocked message, but with the virtual credit card number substituted for the temporary credit card number. Optionally, the virtual identity can include not only a card number but also expiration date and other fields. Control then returns to decision step 140. The behavior of the electronic commerce site 20 in response to a message received resulting from the navigation event of step 152 is identical to the clientless version disclosed above, and will not be repeated in the interest of brevity.

### EXAMPLE 1

Referring again to FIGS. 1 and 2, the use of an exemplary embodiment of the secure private agent 16 is now disclosed in further detail.

The registration process is as follows:

1. The consumer 10 accesses the World Wide Web site maintained by the server 36 of the secure private agent 16 using the communication device 12.

2. The server 36 sends a home page to the communication device 12.

3. The consumer 10 selects the registration option on the home page.

4. The server 36 sends the registration form of the secure private agent 16.

5. The registration form includes the following fields: username; password; and numeric identification (e.g. international phone number—for IVR service).

6. The consumer 10 submits the registration form to the server 36.

7. The back office logic 44, which could reside on the server 36 or communicate with the server 36 from a remote location, determines the availability of the username. If the username is unavailable, the server 36 requests that the consumer 10 select a different username.

8. The back office logic 44 creates a new user profile for the consumer 10.

9. The consumer 10 is invited to add authentication information to his new user profile. Exemplary items of authentication information include best friend's name, mother's maiden name, and the city of birth.

The procedure for consumer internet browsing activity using the secure private agent 16 in a clientless version is as follows:

1. The consumer 10 accesses the World Wide Web site maintained by the server 36 of the secure private agent 16 using the communication device 12.

2. The back office logic 44 identifies the consumer 10 using a cookie in a known manner.

3. The back office logic 44 sends a personalized user services page to the communication device 12 via the server 36. The services page contains the front-end client 52, either an HTML form, or a Java applet, which loads and begins to execute.

4. In some embodiments the front end client 52 displays an HTML document including a frameset. The new window does not display the conventional address menu bar nor the bookmarks menu bar which are currently found in many World Wide Web browsers. Instead the top frame displays a custom user interface, which includes an address bar, a bookmarks bar, command buttons for functions as may be employed by a particular release, and an interaction area for communication of messages, advertisements, or for “chat”.

A bottom frame of the new browser window displays the preferred home page of the consumer 10, or a selection of several preferred World Wide Web sites.

In the new browser window, all links in the displayed HTML document point to the World Wide Web site of the back-end gateway 50 and the conventional address and bookmarks menu bars are displayed.

5. The consumer 10 enters a URL into the address bar of the displayed HTML document or clicks a link. In the case of a typed URL, the front-end client 52 sends the URL to the back-end gateway 50, which fetches the appropriate content, and processes the links to point to the server of the back-end gateway 50. In the case where a link is clicked, the back-end gateway 50 receives an HTTP GET request, fetches the appropriate content and processes the link to point to itself.

6. The bottom frame of the new browser window now displays the new content received from the requested URL.

The purchase transaction is conducted as follows:

1. The consumer 10, having registered, and shopped, arrives at a desired electronic commerce site 20.

2. The consumer 10 selects products or services and places them in the shopping cart.

3. The user selects the checkout function of the electronic commerce site 20.

4. The electronic commerce site 20 presents a form having fields directed to shipping details of the transaction.

5. The back-end gateway 50 identifies the shipping form and inserts the predetermined shipping details of the consumer 10 into the form's fields.

6. The back-end gateway 50 sends the modified form to the browser 48.

7. The consumer 10 modifies the shipping form, if needed, and submits it.

8. The back-end gateway 50 intercepts the shipping information, records it in the profile of the consumer 10 and forwards the information to the electronic commerce site 20.

9. The electronic commerce site 20 processes the shipping information and returns a payment form which is intercepted by the back-end gateway 50.

10. The back-end gateway 50 identifies the payment form and modifies the payment form by inserting temporary values into the form fields.

12. The back-end gateway 50 sends the modified payment form to the browser 48.

13. The consumer 10 reviews the payment information; makes any required changes, and sends it.

114. The back-end gateway 50 receives the payment information from the consumer 10, which indicates that payment is to be made by the secure private agent 16, using the above noted temporary values.

15. The back-end gateway 50 queries the back office logic 44 in order to authenticate the consumer 10. 16. The back-end gateway 50 sends a challenge to the front-end client 52, which requires an answer by the consumer 10.

17. The front-end client 52 presents a window on the display 46 of the communication device 12 asking approval for the transaction and presenting the challenge.

18. The consumer 10 answers the challenge and approves the transaction.

19. The back-end gateway 50 receives the answer and determines if the challenge has been met. If not, the back-end gateway 50 transmits a cancellation page to the communication device 12. The consumer 10 has an opportunity to revisit the page containing the modified payment form and can resend the information to the back-end gateway 50.

20. The back-end gateway 50 informs the back office logic 44 of the transaction.

21. The back office logic 44 generates a unique transaction identifier. Generation of the transaction identifier can be done either on-the-fly, or in some embodiments by calculation, or by allocation from a list, or a range of values.

22. The back office logic 44 informs the credit card issuer 60 of the transaction details including the credit card number to be used, the expiration date of the credit card, and the cardholder name to be used.

23. The back office logic 44 returns the transaction details to the back-end gateway 50.

24. The back-end gateway 50 sends payment information and the transaction details provided by the back office logic 44 to the electronic commerce site 66.

25. The electronic commerce site 66 coordinates the payment information with the clearing house 68.

26. The clearing house 68 coordinates the payment transfer to the electronic commerce site 66 from the credit card issuer 60.

27. The credit card issuer 60 approves the transaction based on the information provided by the back office logic 44.

28. The clearing house 68 clears the transaction based on approval by the credit card issuer 60.

29. The electronic commerce site 66 accepts the transaction based on the approval of the credit card issuer 60.

30. The electronic commerce site 66 sends confirmation information, optionally with a reference number. The confirmation is intercepted by the back-end gateway 50, and is relayed to the consumer 10.

31. The credit card issuer 60 informs the back office logic 44 of the approval of the transaction.

32. The back office logic 44 debits the user account according the transaction amount.

It should be noted that if authorization of the transaction by the electronic commerce site 66 occurs offline, then the sequence of steps 25 onward may be slightly different. The electronic commerce site 66 may send confirmation information before actually authorizing the transaction. However, the authorization process is otherwise identical, and the final messages between the credit card issuer 60 and the back office logic 44 are unchanged.

Details of the functional implementation of the major components of the architecture of the secure private agent 16 are given in Tables 1-2, with reference to FIG. 2. While the focus in Table 1 is on transactions employing a World Wide Web Browser on the internet, the modifications required in order to operate under the wireless application protocol are not significant.

TABLE 1
Front-End Client

| No. | Function | Implementation |
|---|---|---|
| 1 | Open browser win- | Standard applet function |
| | dow | |
| 2 | Display URL in | Standard applet function |
| | browser window | |
| 3 | Get Address (URL) | Function operating on an AWT |
| | | text field (AWT refers to the |
| | | standard Java Library provided |
| | | by Sun Microsystems, Inc., |
| | | Java.AWT), which retrieve the |
| | | URL using functions 1-3 of |
| | | the back-end gateway |
| 4 | Challenge Username | Function which accepts login in- |
| | and Password | formation from the user and sends |
| | | it to the back-end gateway 50 for |
| | | verification |
| 5 | Activate agent | Function which allows the user to |
| | command | select a command from a text or |
| | | graphic menu and sends it to the |
| | | appropriate back-end gateway |
| | | function for execution |

TABLE 2
Credit Card Issuer

| No. | Function | Implementation |
|---|---|---|
| 1 | Receive payment | Function which receive authoriza- |
| | information | tion information for a payment |
| | | transaction |
| 2 | Send payment | Function which informs the back |
| | information | office logic about payments which |
| | | were previously approved by the |
| | | back office logic and were also |
| | | authorized by the credit card issuer |
| 3 | Validate payment | Function that compares a informa- |
| | information | tion of the electronic commerce |
| | | site with information of the back |
| | | office logic concerning author- |
| | | ized transactions to determine |
| | | transaction validity (fraud pro- |
| | | tection) |

TABLE 3
Back-End Gateway

| No. | Function | Implementation |
|---|---|---|
| 1 | Get URL from elec- | Standard Java/Web Server func- |
| | tronic commerce | tion |
| | site | |
| 2 | Reformat URL in | Function to modify URLs |
| | HTML | in HTML tags, such as <a, <img, |
| | | <area, <form |
| 3 | Send HTML to | Standard Web server function |
| | browser | |
| 4 | Get POST informa- | Standard Java/Web Server func- |
| | tion from Browser | tion |
| 5 | Filter POST fields | Function to substitute field val- |
| | | ues |
| 6 | Send POST infor- | Standard Java |
| | mation to electronic | Function |
| | commerce site | |
| 7 | Change form | Function that modifies the form's |
| | values | values |
| 8 | Reformat HTML | Function to modify HTML tags |
| | privacy tags | that may endanger user privacy |
| | | such as <script, <embed, |
| | | etc. |

TABLE 4
Back-Office Logic

| No. | Function | Implementation |
|---|---|---|
| 1 | Clear user payment | Function which debits the user's |
| | | credit card |
| 2 | Debit internal | Function which debits the user's |
| | account | internal account based on a pur- |
| | | chase amount |
| 3 | Credit internal | Function which credits the user's |
| | account | Internal account |
| 4 | Internal transfer | Function which moves credit be- |
| | | tween internal accounts, with op- |
| | | tional commission |
| 5 | Credit purchase | Function which accepts user |
| | | credit purchase order, clears the |
| | | payment and credits the internal |
| | | account |
| 6 | Open new user | Function which registers a new |
| | profile | user in the system |
| 7 | Open new user | Function which activates the |
| | account | user's ability to buy using the |
| | | secure private agent |
| 8 | Retrieve/Update | Function which retrieves informa- |
| | user profile | tion from the user's profile and |
| | | optionally updates this informa- |
| | | tion |
| 9 | Retrieve user | Function to report on account |
| | account | status, balance and transactions |
| 10 | Generate transac- | Function which identifies a user |
| | tion ID | transaction using the secure pri- |
| | | vate agent, to be used either as |
| | | part of credit card number issued |
| | | by the secure private agent or as |
| | | part of the card holder's name |
| 11 | Send transaction | Function which sends transaction |
| | information | information, including its ID, |
| | | to the credit card issuer to sup- |
| | | port payment authorization |
| 12 | Receive transac- | Function which receives author- |
| | tion information | ized payment information from the |
| | | credit card issuer that was sent |
| | | by the electronic commerce site |

The function “Generate transaction ID” (Table 4) operates in accordance with policies appropriate to the identification space available. In some applications only a small number of virtual transaction identifiers are available for use. In such cases a record of activity on each virtual transaction identifier is maintained. In one embodiment reuse of the identifiers is permitted after a predefined period has expired without activity. In other embodiments the identifiers can be reused for transactions by the same consumer with the same electronic commerce site.

In other embodiments the activity space may be large, but the proxy identifiers are intentionally limited in number, and reused in order to avoid overloading the database of the service provider. An example is the use of an e-mail address as a proxy.

Alternative Embodiment

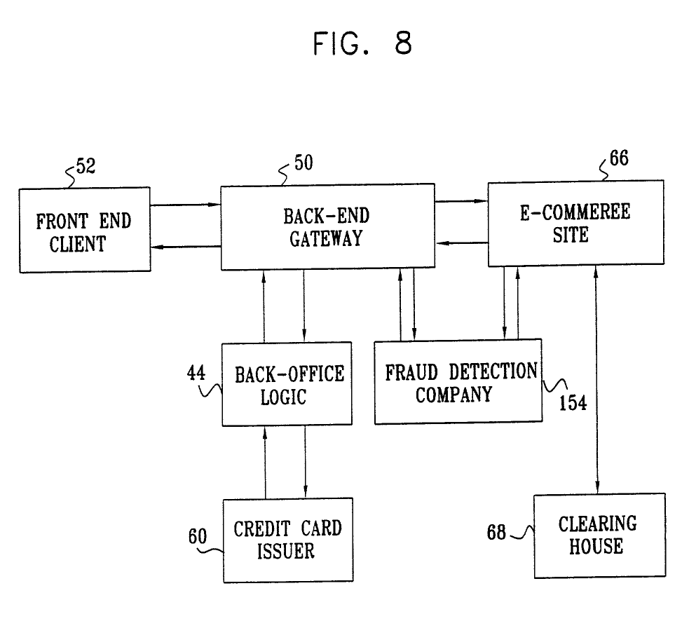

Referring now to FIGS. 1 and 8, in which like reference numbers denote the same element throughout, the techniques according to the present invention facilitate the development of a direct business relationship between the secure private agent, electronic commerce Sites, and fraud detection service companies, which today sometimes perform an initial validation and verification in the credit card clearing process. In this embodiment there is a different, more indirect business relationship between the secure private agent 16 and the credit card issuer 60. As in the previous embodiment, the secure private agent 16 is represented in FIG. 8 by its components, the front-end client 52, the back-end gateway 50, and the back office logic 44.

1. The secure private agent 16 openly publishes a “false” credit card number (FCC) for transactions carried out under its auspices.

2. The false credit card number can be identified by either the electronic commerce site 66 or a fraud detection service company 154.

3. The secure private agent 16 encodes a transaction identification (TID) in the cardholder's name field of a credit card payment form to be submitted.

4. The electronic commerce site 66 or the fraud detection service company 154 can initially validate the transaction identification against the signature provided by the secure private agent 16, and can authorize the identified transaction via an open internet applications programming interface (API).

5. Once an authorization is issued to the electronic commerce site 66 or the fraud detection service company 154 through the open internet applications programming interface, the secure private agent 16 guarantees the transaction payment.

The benefits of this embodiment are the savings of potential commissions which would otherwise be paid by the secure private agent 16 for the operation of the credit card clearing process, including payments to the clearing house 68. The merchant continues to be guaranteed payment, since the secure private agent 16 can verify the identity of the consumer 10. Furthermore there is added security and a strong fraud prevention mechanism because of the participation of the fraud detection service company 154.

Additional Enhancements

Referring again to FIGS. 1-8, in all the preferred embodiments disclosed hereinabove, several enhancements can optionally be offered to the participants in electronic commerce, using the facilities of the secure private agent 16, and in particular the interface provided by the front-end client 52.

1. The secure private agent 16 can maintain a metric indicating credibility of the merchant 18 and the electronic commerce site 20, as well as other statistics relating to information important to merchants, such as purchase values, delivery times, and customer satisfaction. Such statistics are compiled according to ratings provided by clients of the secure private agent 16, represented by the consumer 10.

2. The secure private agent 16 can track delivery of goods, and maintain the delivery status, including expected arrival time, notification at an appropriate interval prior to the actual delivery date, and can provide statistics related to the delivery service.

3. A cache of World Wide Web pages of electronic commerce sites owned by merchants that have a business association with the secure private agent 16 can be maintained by the servers 36, 58. This cache increases the rate of page retrieval, and has a bandwidth sparing effect on the internet. It consequently increases the satisfaction of the consumer 10 with the electronic commerce site 20. In some preferred embodiments, the servers 36, 58 can be realized as multiple regional servers which, in coordination with the back-end gateway 50, facilitate the transactions of multiple consumers who are simultaneously attempting to complete transactions with an electronic commerce site.

### EXAMPLE

Software Agent

A prototype implementation of the software agent has operated in the following environment:

operating System: Windows 2000 or Windows 98;

programming language: Java (Visual J++);

supported browser: Internet Explorer; and

server side simulation: vqserver web server;

The requirements from supported electronic commerce sites were:

send form data by HTTP Post command;

form includes cardholder's name text field;

form includes credit-card number text field;

form includes two digits expiration month field;

form includes two or four digits expiration year field;

alternatively MM/YY single field format is supported;

expiration field names contain the expression “exp”;

month Field contains “m” or “mon”; and

year field contains “y” or “year”

The prototype supported the following cardholder behavior:

fills any required personal information;

selects the system supported credit-card Brand;

fills “apx” in the cardholder's name field (customizable);

fills “123” in the credit-card number field (customizable);

fills any legal values in the expiration fields;

press “buy” button;

fills the payment password in the agent graphical user interface (GUI);

When the software agent is started it first scans open Internet Explorer (IE) windows and registers in order to monitor them. Analyzing events from IE, the Agent traps HTTP Post requests with the designated special field values “apx” and “123”. It pops up the GUI, asking for user authentication by means of a password. Upon sending the server and transaction details, the Agent receives from the server customizable credit card details to be used. It replaces the “name”, “number” and “expiration” fields and re-posts the transaction.

Proxy Server

The prototype implementation of the proxy server succeeded in monitoring the cardholder's surfing path. The following environment was used:

operating system: Windows 98;

programming; Language: Java (JDeveloper)

supported browser: Any browser (The implementation has been tested with IE and Netscape Communicator);

server side: vqServer web server with custom developed servlets;

Requirements from supported sites:

No direct navigation from Java or JavaScript;

Required user behavior:

start from a URL on the server, specifying the starting URL to surf;

receive HTML content as send by the server; and

follow regular HTML links, without Java or JavaScript navigation;

Any other user who connects to the server tracks the surfing route of the first user. The two users receive the same HTML content from the server, and the two stay in synchronization.

While this invention has been explained with reference to the structure disclosed herein, it is not confined to the details set forth and this application is intended to cover any modifications and changes as may come within the scope of the following claims:

What is claimed is:

1. A computer implemented method of conducting secure electronic commerce, comprising the step of:
providing a secure private agent, wherein said secure private agent performs the steps of:
authenticating a login of a consumer onto a server of said secure private agent, said consumer being registered with said secure private agent, wherein said secure private agent is in possession of personal details of said consumer, said personal details comprising a credit card number; and
intercepting a communication between said consumer and an electronic commerce site.

2. The method according to claim 1, wherein said communication includes a static identifier of said consumer that is being transmitted between said consumer and said electronic commerce site.

3. The method according to claim 1, further comprising the step of:
establishing a credit account with a fund controlled by said secure private agent on behalf of said consumer; and
guaranteeing a payment between said consumer and said electronic commerce site from said credit account.

4. The method according to claim 1, wherein said secure private agent further performs the steps of:
generating an identifier that links said consumer to a current transaction between said consumer and said electronic commerce site;
providing said identifier to said electronic commerce site.

5. The method according to claim 4, wherein said identifier is substituted for an actual identifier of said consumer.

6. The method according to claim 5, wherein said actual identifier is a credit card number.

7. The method according to claim 5, wherein said actual identifier is a debit card number.

8. The method according to claim 5, wherein said actual identifier is a bank account number.

9. The method according to claim 5, wherein said actual identifier is a payment card number.

10. The method according to claim 4, wherein said identifier is preallocated.

11. The method according to claim 4, wherein said identifier is subsequently associated with a second transaction of another consumer.

12. The method according to claim 4, wherein said secure private agent further performs the step of monitoring an access of said electronic commerce site by said consumer.

13. The method according to claim 12 wherein said step of monitoring an access is performed by executing a client application of said secure private agent in a communication device at a location of said consumer.

14. The method according to claim 12 wherein said step of monitoring an access is performed by executing a proxy server application of said secure private agent.

15. The method according to claim 4, wherein said secure private agent further performs the step of automatically logging-in said consumer into said electronic commerce site.

16. The method according to claim 4, wherein said secure private agent further performs the step of automatically submitting information relating to said current transaction to said electronic commerce site.

17. The method according to claim 4, wherein said secure private agent further performs the steps of:
automatically logging-in said consumer into said electronic commerce site; and
automatically submitting information relating to said current transaction to said electronic commerce site.

18. The method according to claim 4, wherein said secure private agent provides a guarantee in favor of said electronic commerce site of an obligation that is incurred by said consumer in said current transaction.

19. A computer Implemented method of conducting secure electronic commerce, comprising the steps of:
associating a proxy server with a browser of a party to a transaction, wherein said browser is in communication with an electronic commerce site;
authenticating an identity of said party;
modifying files that are provided by said electronic commerce site such that command instructions carried in said files are routed through said proxy server;
generating an identifier that links said party to a current transaction between said party and said electronic commerce site; and
providing said identifier to said electronic commerce site.

20. The method according to claim 19, further comprising the step of automatically completing transaction details that are required by said electronic commerce site.

21. The method according to claim 19, further comprising the steps of:
translating said identifier into a second identifier that is recognized by a payment processing agent, and communicating said second identifier to said payment processing agent;
wherein responsive to receipt of said second identifier, said payment processing agent authorizes a payment by said party to said electronic commerce site.

22. The method according to claim 21, wherein said step of translating further comprises the steps of:
receiving a request to pre-authorize said payment from a credit card facility; and
pre-authorizing said payment and memorizing the pre-authorization;
wherein said second identifier is a confirmation of said pre-authorization.

23. The method according to claim 21, further comprising the step of:
establishing a credit account with a fund controlled by said proxy server on behalf of said party; and
guaranteeing said payment from said credit account.

24. The method according to claim 19, wherein said step of associating a proxy server is performed by installing a front end client in a computer of said party.

25. The method according to claim 19, wherein said step of generating an identifier further comprises substituting said identifier for a credit card number of said party.

26. A computer system for conducting electronic commerce, comprising:
a front end client application, executing on a computer of a user;
a back-office logic application linked to a transaction processor;
a back-end gateway application, linked to said front end client application, and linked to said back-office logic application via a data network, and communicating with a commerce site; wherein said back-end gateway application intercepts communications between said user and said commerce site;
wherein responsive to a static identifier that is directed by said user to said commerce site in a first communication, said back-end gateway application blocks said first communication, and said back-office logic application generates a virtual identifier;
wherein said back-end gateway application communicates said virtual identifier to said commerce site in a second communication; and said back-office logic application communicates an actual identifier to said transaction processor in a third communication.

27. The computer system according to claim 26, wherein said virtual identifier is subsequently associated with a second transaction of another user.

28. The computer system according to claim 26, wherein said front end client application and said back-end gateway application execute in said computer of said user.

29. The computer system according to claim 26, wherein said back-end gateway application and said back-office logic application execute on at least one server that is linked to said data network.

30. The computer system according to claim 26, wherein said virtual identifier is a credit card number.

31. The computer system according to claim 26, wherein said actual identifier is a credit card number.

32. The computer system according to claim 26, wherein said virtual identifier is a credit card number, and said actual identifier is a credit number.

33. A computer software product, comprising a computer-readable medium in which computer program instructions are stored, which instructions, when read by a computer, cause the computer to perform the steps of:
associating a proxy server with a browser of a party to a transact-on, wherein said browser is in communication with an electronic commerce site;
authenticating an identity of said party;
modifying files that are provided by said electronic commerce site such that command instructions carried in said files are routed through said proxy server; and
providing an identifier that links said party to a current transaction between said party and said electronic commerce site; to said identifier to said electronic commerce site.

34. The computer software product according to claim 33, wherein the computer further performs the step of automatically completing transaction details that are required by said electronic commerce site.

35. The computer software product according to claim 33, wherein the computer further performs the steps of:
establishing a communications channel between said proxy server and a payment processing agent; and
authorizing a payment by said party to said electronic commerce site to said payment processing agent.

36. The computer software product according to claim 33, wherein said step of associating said proxy server is performed by installing a front end client in a computer of said party.

37. The computer software product according to claim 33, wherein said step of generating an identifier further comprises substituting said identifier for a credit card number of said party.

38. A computer software product, comprising a computer-readable medium in which computer program instructions are stored, which instructions, when read by a computer, cause the computer to perform the steps of:
intercepting a communication between a browser of a party to a transaction and an electronic commerce site;
authenticating an identity of said party;
receiving an identifier that links said party to a current transaction between said party and said electronic commerce site; and
providing said identifier to said electronic commerce site.

39. The computer software product according to claim 38, wherein the computer further performs the step of automatically completing transaction details that are required by said electronic commerce site.

40. The computer software product according to claim 38, wherein said step of providing said identifier further comprises substituting said identifier for a credit card number of said party.
